(19) United States
(12) Patent Application Publication
(10) Pub. No.: US 2026/0310570 A1
(43) Pub. Date: Oct. 8, 2026

(54) PROVIDING ACCESS TO COMPUTING DEVICES OF AN INFORMATION HANDLING SYSTEM

(71) Applicant: Dell Products L.P., Round Rock, TX (US)

(72) Inventors: Alan Helmy Abdelhalim, Pflugerville, TX (US); Jacob Vincent Mink, Cedar Park, TX (US); Yves Christian Dolce, Redmond, WA (US)

(21) Appl. No.: 19/173,075

(22) Filed: Apr. 8, 2025

(51) Int. Cl. G06F 11/30; G06F 9/445

(52) U.S. Cl. CPC G06F 11/3051; G06F 9/44526

(57) ABSTRACT

Providing access to computing devices, including: receiving a request for property attributes of a computing device; in response to receiving the request: identifying properties of the request; accessing a first extension plugin associated with the computing device; determining that the first extension plugin supports the request; in response to determining that the first extension plugin supports the request: determining that there is a second extension plugin associated with the computing device; in response to determining that there is a second extension plugin associated with the computing device: accessing the second extension plugin associated with the computing device; determining that the second extension plugin does not support the request; in response to determining that the second extension plugin does not support the request: determining that there are no further extension plugins associated with the computing device, and in response, performing, utilizing the first extension plugin, an operation at the computing device.

### BACKGROUND

### Field of the Disclosure

The disclosure relates generally to an information handling system, and in particular, providing access to computing devices of the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

APIs, or Application Programming Interfaces, are tools that allow different software applications to communicate with each other. APIs define the methods and data formats that applications can use to request and exchange information. APIs are essential for integrating various systems, enabling functionalities like retrieving data from a server or connecting to third-party services. They play a crucial role in modern software development, making it easier to build complex applications efficiently.

### SUMMARY

Innovative aspects of the subject matter described in this specification may be embodied in a method of providing access to computing devices of an information handling system, including: receiving, from a client computing module, a request for property attributes of a computing device; in response to receiving the request: identifying properties of the request; accessing a first extension plugin associated with the computing device; determining that the first extension plugin supports the request; in response to determining that the first extension plugin supports the request: determining that there is a second extension plugin associated with the computing device; in response to determining that there is a second extension plugin associated with the computing device: accessing the second extension plugin associated with the computing device; determining that the second extension plugin does not support the request; in response to determining that the second extension plugin does not support the request: determining that there are no further extension plugins associated with the computing device, and in response, performing, utilizing the first extension plugin, an operation at the computing device.

Other embodiments of these aspects include corresponding systems, apparatus, and computer programs, configured to perform the actions of the methods, encoded on computer storage devices.

These and other embodiments may each optionally include one or more of the following features. For instance, determining that the second extension plugin does support the request, and in response, providing an error signal. Determining that there is no further extension plugin associated with the computing device, and in response, performing, utilizing the first extension plugin, the operation at the computing device. Determining that the first extension plugin does not support the request; in response to determining that the first extension plugin does not support the request: determining that there is no further extension plugin associated with the computing device, and in response: accessing a base plugin associated with the computing device; and determining that the base plugin supports the request, and in response, performing, utilizing the base plugin, the operation at the computing device. Determining that the first extension plugin does not support the request; in response to determining that the first extension plugin does not support the request: determining that there is no further extension plugin associated with the computing device, and in response: accessing a base plugin associated with the computing device; and determining that the base plugin does not support the request, and in response, providing an error signal.

Particular implementations of the subject matter described in this specification can be implemented so as to realize one or more of the following advantages. For example, seamless integration of computer-executable applications with hardware/software of third-party vendors.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for providing access to computing devices.

FIG. 3 illustrates a method for providing access to computing devices.

### DESCRIPTION OF PARTICULAR EMBODIMENT(S)

This disclosure discusses methods and systems for providing access to computing devices of an information handling system. In short, computer-implemented applications frequently require access to proprietary APIs, whether developed by the manufacturer of the information handling system or sourced from third parties. The present invention facilitates seamless, unified access to the property attributes via APIs, described further herein.

Specifically, this disclosure discusses a system and a method for providing access to computing devices of an information handling system, including receiving, from a client computing module, a request for property attributes of a computing device; in response to receiving the request: identifying properties of the request; accessing a first extension plugin associated with the computing device; determining that the first extension plugin supports the request; in response to determining that the first extension plugin supports the request: determining that there is a second extension plugin associated with the computing device; in response to determining that there is a second extension plugin associated with the computing device: accessing the second extension plugin associated with the computing device; determining that the second extension plugin does not support the request; in response to determining that the second extension plugin does not support the request: determining that there are no further extension plugins associated with the computing device, and in response, performing, by the client computing module and utilizing the first extension plugin, an operation at the computing device.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

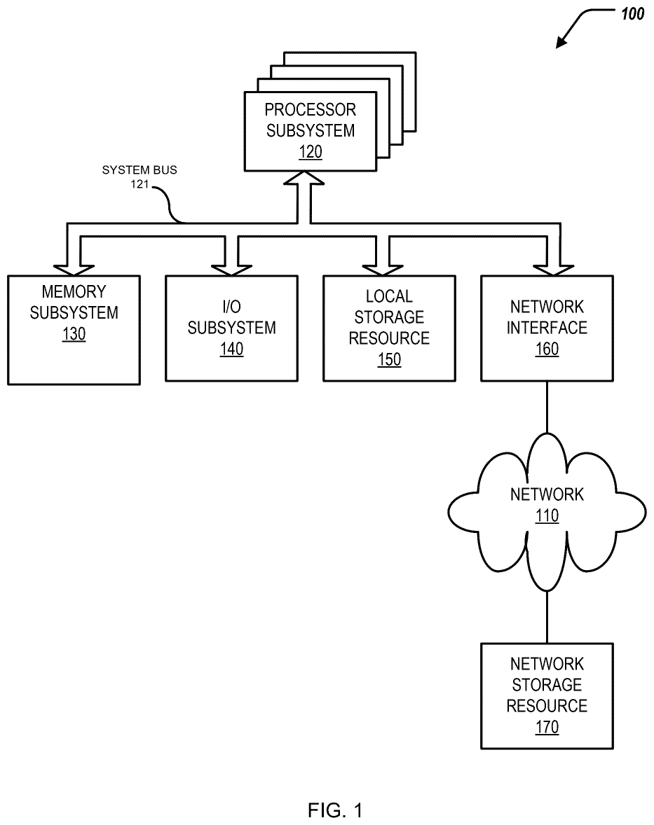

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

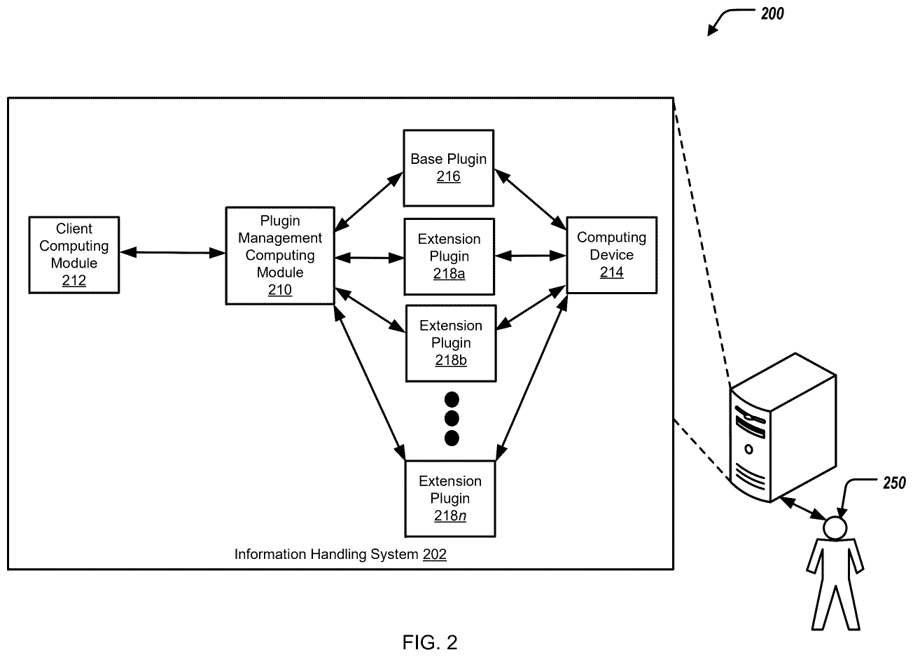

Turning to FIG. 2, FIG. 2 illustrates an environment 200 including an information handling system 202. The information handling system 202 can include a plugin management computing module 210, a client computing module 212, computing device 214, a base plugin 216, and extension plugins 218a, 218b, . . . , 218n (collectively referred to as extension plugins 218). In some examples, the information handling system 202 is similar to, or includes, the information handling system 100 of FIG. 1.

The plugin management computing module 210 can be in communication with the client computing module 212, the base plugin 216, and the extension plugins 218. The client computing module 212 can be in communication with the plugin management computing module 210. The computing device 214 can be in communication with the base plugin 216, and the extension plugins 218.

The computing device 214 can include memory, storage devices, video cards, monitor, audio cards, processors, and the like.

The client computing module 212 can further be in communication with one or more of the base plugin 216 and/or the extension plugin 218, based on the implementation (not shown for ease of illustration). That is, the client computing module 212 can be in communication with one or more of the base plugin 216, the extension plugin 218a, the extension plugin 218b, . . . , the extension plugin 218n.

In some examples, the client computing module 212 can include a computer-implemented application (or computer-executable application, or computer software, or computer-executable software), or be a representation of the computer-implemented application.

The base plugin 216 and the extension plugins 218 can facilitate communication and interaction with the computing device 214, described further herein. The extension plugins 218 can support differing sets of operations of the computing device 214. In some examples, the operations can include access of properties of the computing device 214, such as telemetry data of the computing device 214. The telemetry data can represent properties, parameters, and the like, of the computing device 214. For example, the telemetry data can include processor parameters, temperature of the computing device 214, processing parameters of the computing device 214, data access parameters of memory, battery information, battery state, battery state of charge (SOC), network performance parameters and speed, BIOS version, OS version, and the like. In some examples, the property attributes can include a volume of speakers, physical location of the speakers, serial number of the computing device 214, distortion or auto-leveling of the speaker, battery management (“BatMan”) information of the battery, and the like.

In some examples, the operations can include updating data and/or properties at the computing device 214. For example, when the computing device 214 is a speaker, the operations can include updating a speaker volume at the computing device 214. For example, when the computing device 214 is a display (monitor), the operations can include updating a resolution of the display.

In some examples, the operations can include invoking/calling a computing method to be performed at the computing device 214. For example, invoking the computing method could include flashing firmware of the computing device 214.

In some examples, the base plugin 216 is provided by an original equipment manufacturer (OEM) of the computing device 214. For example, when the computing device 214 is a battery, the OEM manufacturer can be a manufacturer of the battery. The base plugin 216 is the “originally loaded plugin” that supports a base set of operations of the computing device 214. The base plugin 216 supports the computing device 214 and the base set of operations of the computing device 214 by a computing device identifier (DeviceID) (e.g., commodity type such as a battery, monitor or speakers) and by an item identifier (ItemID) (e.g., Battery_0, CPU_0, Speaker_2, and the like). The base plugin 216 is supported “out-of-the-box” by a software development kit (SDK) of the computing device 214.

The base plugin 216 can support the base set of operations of the computing device 214 such as a serial number of the computing device 214, and a state of charge (SOC) of the computing device 214 (battery).

In some examples, the extension plugin 218 is an extension plugin that is loaded by an external installer. The extension plugin 218 is enabled at the information handling system 202 by an installer external to the computing device 214. Specifically, the extension plugin 218 is enabled by a manufacturer of the information handling system 202. That is, the extension plugin 218 can be enabled by a third party to the computing device 214 and a third party to the client computing module 212. That is, the extension plugin 218 can be enabled by the information handling system 202. The extension plugin 218 is associated with a third-party entity separate from the computing device 214.

Each of the extension plugins 218 supports a respective extension set of operations of the computing device 214. Each extension plugin 218 supports the computing device 214 and the respective extension set of operations of the computing device 214 by the computing device identifier (DeviceID) and by the item identifier (ItemID). In some examples, the extension set of properties of each extension plugin 218 differs from one another. In some examples, the extension set of properties of at least one extension plugin 218 overlaps with another extension set of properties of another extension plugin 218.

In some examples, the base set of properties supported by the base plugin 216 differs from each of the extension sets of operations supported by the respective extension plugins 218. In some examples, the base set of operations supported by the base plugin 216 overlaps with at least one extension set of operations supported by the respective extension plugins 218. That is, at least one operation of the base set of operations supported by the base plugin 216 is also included by the extension set of operations supported by one or more of the extension plugins 218. In some examples, the extension plugin 218 does not need to support the base set of operations that is supported by the base plugin 216 (i.e., “lower layers”). In other words, the extension plugin 218 supports operations that are not supported by the base plugin 216; or unable to be supported by the base plugin 216.

The extension plugin 218 can support the second set of operations of the computing device 214 such as an extension commodity for a speaker (computing device 214) for controlling levels of distortion or auto-leveling of the volume of the speaker in response to external stimuli. The second set of operations can include battery management (“BatMan”) telemetry data of the computing device 214 (battery). The second set of operations can include a swelling state of a battery (computing device 214).

In some examples, the extension plugin 218 is an extension plugin that is loaded by an external installer. The extension plugin 218 is enabled at the information handling system 202 by the client computing module 212. That is, the client computing module 212 installs, or enables installing, of the extension plugin 218 at the information handling system 202 to expose operations (attributes/features) of the computing device 214.

In short, computer-implemented applications (such as the client computing module 212) frequently require access to proprietary APIs, whether developed by the manufacturer of the information handling system 202 or sourced from third parties. The present invention facilitates seamless, unified access to the property attributes via the plugins 216, 218, described further herein.

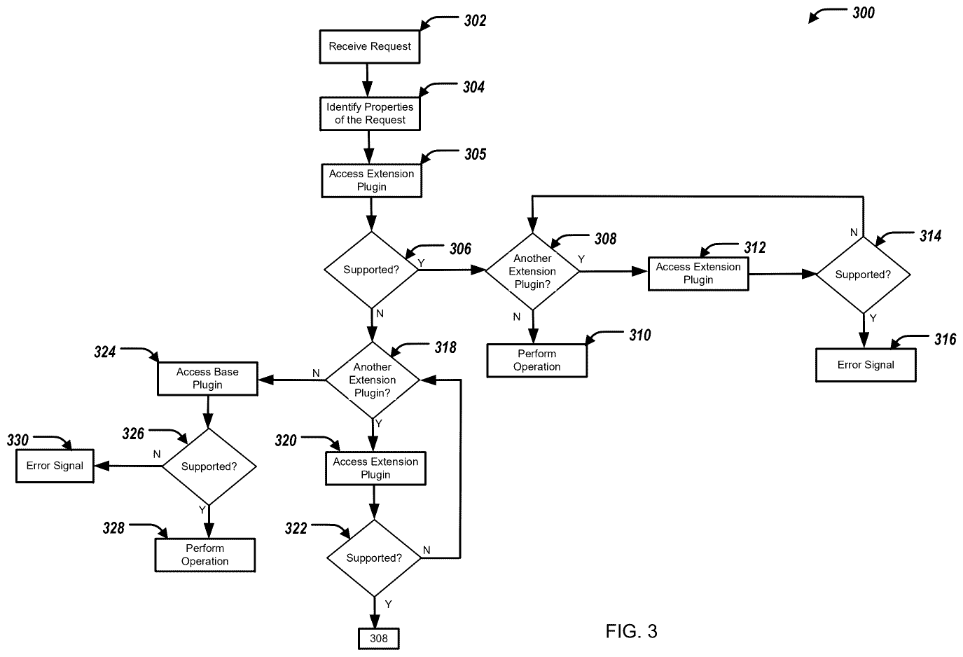

FIG. 3 illustrates a flowchart depicting selected elements of an embodiment of a method 300 for providing access to computing devices. The method 300 may be performed by the information handling system 100, the information handling system 202, the plugin management computing module 210, the client computing module 212, the base plugin 216, and/or the extension plugin 218 and with reference to FIGS. 1-2. It is noted that certain operations described in method 300 may be optional or may be rearranged in different embodiments.

The plugin management computing module 210 receives, from the client computing module 212, a request for operations of the computing device 214, at 302. In some examples, the request for operations can include a request for data of the computing device 214 (such as telemetry data). In some examples, the request for operations can include a request to update properties at the computing device 214. In some examples, the request can include a request to invoke a computing method at the computing device 214.

In response to the request, the plugin management computing module 210 identifies properties of the request, at 304. For example, the request can include a DeviceID, an ItemID, and an operation to be performed at the computing device 214.

The plugin management computing module 210 accesses a particular extension plugin 218 that is associated with the computing device 214, at 305. Specifically, the plugin management computing module 210 identifies the DeviceID, the ItemID, and the extension set of operations that are supported by the particular extension plugin 218.

Further in response to the request, the plugin management computing module 210 determines whether the particular extension plugin 218 supports the request, at 306. Specifically, the plugin management computing module 210 compares the request with the particular extension plugin 218, and in particular, compares the DeviceID, the ItemID, and the operation of the request with what the particular extension plugin 218 supports. That is, whether the particular extension plugin 218 supports the DeviceID, ItemID, and the operation of the request. The plugin management computing module 210 determines whether the particular extension plugin 218 supports the DeviceID and the ItemID of the request. Further, the particular extension plugin 218 can support a particular extension set of operations, and the plugin management computing module 210 determines whether the operation of the request is included by the particular extension set of operations of the particular extension plugin 218.

In some examples, the plugin management computing module 210 determines that the request is supported by the particular extension plugin 218 (at 306). That is, the plugin management computing module 210 determines that the particular extension plugin 218 supports the DeviceID, the ItemID, and the operation of the request. In response to determining that the request is supported by the particular extension plugin 218, the plugin management computing module 210 determines whether an additional extension plugin 218 supports the request. Specifically, in response to determining that the request is supported by the particular extension plugin 218 (at 306), the plugin management computing module 210 determines whether there is an additional extension plugin 218 included at the information handling system 202, at 308.

In some examples, the plugin management computing module 210 determines that there are not additional extension plugins 218 included at the information handling system 202 (at 308), and in response, performs the operation, at 310. That is, the plugin management computing module 210 notifies the client computing module 212 to utilize the particular extension plugin 218 to access the computing device 214. The client computing module 212 then utilizes the particular extension plugin 218, through the plugin management computing module 210, to access the computing device 214 to perform the operation at the computing device 214. That is, the client computing module 212 communicates with the plugin management computing module 210 for access to the computing device 214, and in particular, the plugin management computing module 210 communicates with the computing device 214 utilizing the particular extension plugin 218 on behalf of the client computing module 212. In other words, the client computing module 212 performs the operation at the computing device 214 by communicating the request to the plugin management computing module 210; and the plugin management computing module 210 then communicates with (in response to receiving the request) the computing device 214 utilizing the particular extension plugin 218.

For example, when the request is for battery management telemetry data of the computing device 214 (battery), plugin management computing module 210 utilizes the particular extension plugin 218 to access the data of the computing device 214 on behalf of the client computing module 212.

In some examples, plugin management computing module 210 utilizes the particular extension plugin 218 (on behalf of the client computing module 212 and in response to the request) to access the computing device 214 to access data associated with the computing device 214 from the computing device 214. In some examples, plugin management computing module 210 utilizes the particular extension plugin 218 (on behalf of the client computing module 212 and in response to the request) to access the computing device 214 to update data associated with the computing device 214 at the computing device 214. In some examples, the client computing module 212 utilizes plugin management computing module 210 to invoke a computing method at the computing device 214 (on behalf of the client computing module 212 and in response to the request).

The plugin management computing module 210 performs the operation (accessing data, updating data, and/or invoking a computing method) at the computing device 214 (on behalf of the client computing module 212 and in response to the request) independent of user action by a user 250 of the information handling system. That is, the plugin management computing module 210 performs the operation at the information handling system 202 (and specifically, at the computing device 214) automatically in response to receiving the indication of which plugin to utilize to access the computing device 214. The plugin management computing module 210 can perform the operation to provide operability of the computing features of the computing device 214 by improving performance capabilities of the information handling system 202 (such as the computing device 214). That is, performing the operation to/at the computing device 214 by the plugin management computing module 210 improves the performance capabilities of the information handling system 202 (the computing device 214) such that the functionality and the operability of the computing features of the computing device 214 is improved. In some examples, the plugin management computing module 210 can perform the operation to improve the performance capabilities of the information handling system 202 without user action/input by the user 250 (independent of user action/input by the user 250).

In some examples, the plugin management computing module 210 can perform the operation of uninstalling a driver associated with the computing device 214 without input/interaction by the user 250. That is, the plugin management computing module 210 can uninstall, or facilitate uninstallation of, the driver at the computing device 214 automatically in response to receiving the indication of which plugin to utilize to access the computing device 214.

In some examples, the plugin management computing module 210 can perform the operation of updating a driver associated with the computing device 214 without input/interaction by the user 250. That is, the plugin management computing module 210 can update, or facilitate updating of, the driver at the computing device 214 automatically in response to receiving the indication of which plugin to utilize to access the computing device 214.

In some examples, the plugin management computing module 210 can perform the operation of disabling a driver associated with the computing device 214 without input/interaction by the user 250. That is, the plugin management computing module 210 can disable, or facilitate disabling of, the driver at the computing device 214 automatically in response to receiving the indication of which plugin to utilize to access the computing device 214.

In some examples, the plugin management computing module 210 can perform the operation of installing a new driver associated with the computing device 214 without input/interaction by the user 250. That is, the plugin management computing module 210 can install, or facilitate installing of, the new driver at the computing device 214 automatically in response to receiving the indication of which plugin to utilize to access the computing device 214.

In some examples, the plugin management computing module 210 can perform the operation of updating firmware associated with the computing device 214 without input/interaction by the user 250. That is, the plugin management computing module 210 can update, or facilitate updating of, the firmware at the computing device 214 automatically in response to receiving the indication of which plugin to utilize to access the computing device 214.

In some examples, the plugin management computing module 210 can perform the operation of updating a configuration associated with the computing device 214 without input/interaction by the user 250. That is, the plugin management computing module 210 can update, or facilitate updating of, the configuration at the computing device 214 automatically in response to receiving the indication of which plugin to utilize to access the computing device 214.

In some examples, the plugin management computing module 210, in response to performing the operation of receiving the property attributes of the computing device 214 that indicates the SOC of the computing device 214, can further disable any battery-related operations, such as battery-related data operations for determining a health of the battery, or disable or throttle power intensive applications, when the SOC is below a threshold without input/interaction by the user 250.

In some examples, the plugin management computing module 210, in response to performing the operation of receiving the property attributes of the computing device 214 that indicates the transmission rate of the computing device 214, can further adjust what data is transmitted over the network interface (e.g., priority data) when the transmission rate is below a threshold without input/interaction by the user 250.

In some examples, the request is additionally supported by the base plugin 216. That is, the base plugin 216 supports the DeviceID, ItemID, and the operation of the request. However, the particular extension plugin 218 (and all extension plugins 218) take precedence over the base plugin 216 for access to the computing device 214. That is, the extension plugins 218 take precedence over the base plugin 216 when both support the request. That is, the plugin management computing module 210 “checks” the extension plugins 218 first/before determining if the base plugin 216 supports the request.

In some examples, the plugin management computing module 210 determines that there are additional extension plugins 218 included at the information handling system 202 (at 308), and in response, the plugin management computing module 210 accesses a further extension plugin 218 that is associated with the computing device 214, at 312. Specifically, the plugin management computing module 210 identifies the DeviceID, the ItemID, and the further extension set of operations that are supported by the further extension plugin 218.

Further in response to the request, the plugin management computing module 210 determines whether the further extension plugin 218 supports the request, at 314. Specifically, the plugin management computing module 210 compares the request with the further extension plugin 218, and in particular compares the DeviceID, the ItemID, and the operation of the request with what the further extension plugin 218 supports. That is, whether the further extension plugin 218 supports the DeviceID, ItemID, and the operation of the request. The plugin management computing module 210 determines whether the further extension plugin 218 supports the DeviceID and the ItemID of the request. Further, the further extension plugin 218 can support a further extension set of operations, and the plugin management computing module 210 determines whether the operation of the request is included by the further extension set of operations of the further extension plugin 218.

In some examples, the plugin management computing module 210 determines that the request is supported by the further extension plugin 218 (at 314). That is, the plugin management computing module 210 determines that the further extension plugin 218 supports the DeviceID, the ItemID, and the operation of the request. In response to determining that the request is supported by the further extension plugin 218, the plugin management computing module 210 sends an error signal to the client computing module 212, at 316. That is, when two or more extension plugins 218 both support the request, the plugin management computing module 210 cannot determine which extension plugin 218 to provide access to the client computing module 212 (e.g., which extension plugin 218 has precedent/priority), and in response, provides the error signal to the client computing module 212 indicating that the request could not be fulfilled.

In some examples, the plugin management computing module 210 determines that the request is not supported by the further extension plugin 218 (at 314). That is, the plugin management computing module 210 determines that the further extension plugin 218 does not support one or more of the DeviceID, the ItemID, and the operation of the request. In response to determining that the request is not supported by the further extension plugin 218, the plugin management computing module 210 returns to step 308.

In some examples, the plugin management computing module 210 determines that the request is not supported by the particular extension plugin 218 (at 306). That is, the plugin management computing module 210 determines that the particular extension plugin 218 does not support one or more of the DeviceID, the ItemID, and the operation of the request. In response to determining that the request is not supported by the particular extension plugin 218, the plugin management computing module 210 determines whether there is an additional extension plugin 218 included at the information handling system 202, at 318.

In some examples, the plugin management computing module 210 determines that there are additional extension plugins 218 included at the information handling system 202 (at 318), and in response, the plugin management computing module 210 accesses an additional extension plugin 218 that is associated with the computing device 214, at 320. Specifically, the plugin management computing module 210 identifies the DeviceID, the ItemID, and the additional extension set of operations that are supported by the additional extension plugin 218.

Further in response to the request, the plugin management computing module 210 determines whether the additional extension plugin 218 supports the request, at 322. Specifically, the plugin management computing module 210 compares the request with the additional extension plugin 218, and in particular compares the DeviceID, the ItemID, and the operation of the request with what the additional extension plugin 218 supports. That is, whether the additional extension plugin 218 supports the DeviceID, ItemID, and the operation of the request. The plugin management computing module 210 determines whether the additional extension plugin 218 supports the DeviceID and the ItemID of the request. Further, the additional extension plugin 218 can support an additional extension set of operations, and the plugin management computing module 210 determines whether the operation of the request is included by the additional extension set of operations of the additional extension plugin 218.

In some examples, the plugin management computing module 210 determines that the request is not supported by the additional extension plugin 218 (at 322). That is, the plugin management computing module 210 determines that the additional extension plugin 218 does not support one or more of the DeviceID, the ItemID, and the operation of the request. In response to determining that the request is not supported by the additional extension plugin 218, the method returns to step 318.

In some examples, the plugin management computing module 210 determines that the request is supported by the particular extension plugin 218 (at 322). That is, the plugin management computing module 210 determines that the additional extension plugin 218 supports the DeviceID, the ItemID, and the operation of the request. In response to determining that the request is supported by the additional extension plugin 218, the method proceeds to step 308.

In some examples, the plugin management computing module 210 determines that there are not additional extension plugins 218 included at the information handling system 202 (at 318), and in response, the plugin management computing module 210 accesses the base plugin 216 that is associated with the computing device 214, at 324. Specifically, the plugin management computing module 210 identifies the DeviceID, the ItemID, and the base set of operations that are supported by the base plugin 216.

The plugin management computing module 210 determines whether the base plugin 216 supports the request, at 326. Specifically, the plugin management computing module 210 compares the request with the base plugin 216, and in particular compares the DeviceID, the ItemID, and the operation of the request with what the base plugin 216 supports. That is, whether the base plugin 216 supports the DeviceID, ItemID, and the operation of the request. The plugin management computing module 210 determines whether the base plugin 216 supports the DeviceID and the ItemID of the request. Further, the base plugin 216 can support a base set of operations, and the plugin management computing module 210 determines whether the operation of the request is included by the base set of operations of the base plugin 216.

In some examples, the plugin management computing module 210 determines that the request is supported by the base plugin 216 (at 326). That is, the plugin management computing module 210 determines that the base plugin 216 supports the DeviceID, the ItemID, and the operation of the request. In response to determining that the request is supported by the base plugin 216, the plugin management computing module 210 performs the operation, at 328, similar to that of step 310. That is, the plugin management computing module 210 notifies the client computing module 212 to utilize the base plugin 216 to access the computing device 214. The client computing module 212 then utilizes the base plugin 216, through the plugin management computing module 210, to access the computing device 214 to perform the operation at the computing device 214. That is, the client computing module 212 communicates with the plugin management computing module 210 for access to the computing device 214, and in particular, the plugin management computing module 210 communicates with the computing device 214 utilizing the base plugin 216 on behalf of the client computing module 212. In other words, the client computing module 212 performs the operation at the computing device 214 by communicating the request to the plugin management computing module 210; and the plugin management computing module 210 then communicates with (in response to receiving the request) the computing device 214 utilizing the base plugin 216.

In some examples, the plugin management computing module 210 determines that the request is not supported by the base plugin 216 (at 326). That is, the plugin management computing module 210 determines that the base plugin 216 does not support one or more of the DeviceID, the ItemID, and the operation of the request. In response to determining that the request is not supported by the base plugin 216, the plugin management computing module 210 sends an error signal to the client computing module 212, at 330. That is, when none of the base plugin 216 and the extension plugins 218 support the request, the plugin management computing module 210 provides the error signal to the client computing module 212 indicating that the request could not be fulfilled.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of providing access to computing devices of an information handling system, including:
receiving, from a client computing module, a request for property attributes of a computing device;
in response to receiving the request:
identifying properties of the request;
accessing a first extension plugin associated with the computing device;
determining that the first extension plugin supports the request;
in response to determining that the first extension plugin supports the request:
determining that there is a second extension plugin associated with the computing device;
in response to determining that there is a second extension plugin associated with the computing device:
accessing the second extension plugin associated with the computing device;
determining that the second extension plugin does not support the request;
in response to determining that the second extension plugin does not support the request: p4 determining that there are no further extension plugins associated with the computing device, and in response, performing, utilizing the first extension plugin, an operation at the computing device.

2. The computer-implemented method of claim 1, further including:
determining that the second extension plugin does support the request, and in response, providing an error signal.

3. The computer-implemented method of claim 1, further including:
determining that there is no further extension plugin associated with the computing device, and in response, performing, utilizing the first extension plugin, the operation at the computing device.

4. The computer-implemented method of claim 1, further including:
determining that the first extension plugin does not support the request;
in response to determining that the first extension plugin does not support the request:
determining that there is no further extension plugin associated with the computing device, and in response:
accessing a base plugin associated with the computing device; and
determining that the base plugin supports the request, and in response, performing, utilizing the base plugin, the operation at the computing device.

5. The computer-implemented method of claim 1, further including:
determining that the first extension plugin does not support the request;
in response to determining that the first extension plugin does not support the request:
determining that there is no further extension plugin associated with the computing device, and in response:
accessing a base plugin associated with the computing device; and
determining that the base plugin does not support the request, and in response, providing an error signal.

6. An information handling system comprising a processor having access to memory media storing instructions executable by the processor to perform operations, comprising:
receiving, from a client computing module, a request for property attributes of a computing device;
in response to receiving the request:
identifying properties of the request;
accessing a first extension plugin associated with the computing device;
determining that the first extension plugin supports the request;
in response to determining that the first extension plugin supports the request:
determining that there is a second extension plugin associated with the computing device;
in response to determining that there is a second extension plugin associated with the computing device:
accessing the second extension plugin associated with the computing device;
determining that the second extension plugin does not support the request;
in response to determining that the second extension plugin does not support the request:
determining that there are no further extension plugins associated with the computing device, and in response, performing, utilizing the first extension plugin, an operation at the computing device.

7. The information handling system of claim 6, the operations further including:
determining that the second extension plugin does support the request, and in response, providing an error signal.

8. The information handling system of claim 6, the operations further including:
determining that there is no further extension plugin associated with the computing device, and in response, performing, by the client computing module, the operation at the computing device.

9. The information handling system of claim 6, the operations further including:
determining that the first extension plugin does not support the request;
in response to determining that the first extension plugin does not support the request:
determining that there is no further extension plugin associated with the computing device, and in response:
accessing a base plugin associated with the computing device;
determining that the base plugin supports the request, and in response, performing, utilizing the base plugin, the operation at the computing device.

10. The information handling system of claim 6, the operations further including:
determining that the first extension plugin does not support the request;
in response to determining that the first extension plugin does not support the request:
determining that there is no further extension plugin associated with the computing device, and in response:
accessing a base plugin associated with the computing device;
determining that the base plugin does not support the request, and in response, providing an error signal.

11. A non-transitory computer-readable medium storing software comprising instructions executable by one or more computers which, upon such execution, cause the one or more computers to perform operations comprising:
receiving, from a client computing module, a request for property attributes of a computing device;
in response to receiving the request:
identifying properties of the request;
accessing a first extension plugin associated with the computing device;
determining that the first extension plugin supports the request;
in response to determining that the first extension plugin supports the request:
determining that there is a second extension plugin associated with the computing device;
in response to determining that there is a second extension plugin associated with the computing device:
accessing the second extension plugin associated with the computing device;
determining that the second extension plugin does not support the request;
in response to determining that the second extension plugin does not support the request:
determining that there are no further extension plugins associated with the computing device, and in response, performing, utilizing the first extension plugin, an operation at the computing device.

12. The non-transitory computer-readable medium of claim 11, the operations further including:
determining that the second extension plugin does support the request, and in response, providing an error signal.

13. The non-transitory computer-readable medium of claim 11, the operations further including:
determining that there is no further extension plugin associated with the computing device, and in response, performing, utilizing the first extension plugin, the operation at the computing device.

14. The non-transitory computer-readable medium of claim 11, the operations further including:
determining that the first extension plugin does not support the request;
in response to determining that the first extension plugin does not support the request:
determining that there is no further extension plugin associated with the computing device, and in response:
accessing a base plugin associated with the computing device;
determining that the base plugin supports the request, and in response, performing, b utilizing the base plugin, the operation at the computing device.

15. The non-transitory computer-readable medium of claim 11, the operations further including:
determining that the first extension plugin does not support the request;
in response to determining that the first extension plugin does not support the request:
determining that there is no further extension plugin associated with the computing device, and in response:
accessing a base plugin associated with the computing device;
determining that the base plugin does not support the request, and in response, providing an error signal.
